(19) United States
(12) Patent Application Publication
(10) Pub. No.: US 2005/0220603 A1
(43) Pub. Date: Oct. 6, 2005

(54) Skid loader attachment for pouring concrete

(76) Inventor: Gregory L. Graham, Norton, KS (US)

Correspondence Address: Richard C. Litman;LITMAN LAW OFFICES, LTD., P.O. Box 15035, Arlington, VA, 22215, US

(21) Appl. No.: 10/816,917

(22) Filed: Apr. 5, 2004

(51) Int. Cl. B65G 1/00

(52) U.S. Cl. 414/724

(57) ABSTRACT

The skid loader attachment for pouring concrete is an accessory attachment that mounts within a loader bucket to form, along with the loader bucket, a container for carrying and pouring a flowable structural material, such as concrete. A generally square chute forms the center of the skid loader attachment for pouring concrete. Angled walls extend outward from each side of the chute. In one embodiment, the walls are adjustable to fit loader buckets of various size. With the skid loader attachment for pouring concrete placed into a loader bucket, the angled walls extend to the sides of the bucket to form front walls of a container, the loader bucket forming the bottom, side, and rear walls of the container. A sliding gate at the front of the chute allows the chute to be opened for dispensing concrete, or closed to contain the concrete, such as during transport.

### BACKGROUND OF THE INVENTION

1. Field of the Invention

The present invention relates to an accessory attachment for a loader vehicle for pouring a flowable material, such as concrete. More specifically, the present invention is an accessory attachment for insertion into the bucket of a skid loader or similar vehicle to facilitate handling and pouring concrete.

2. Description of the Related Art

Flowable structural materials, such as concrete, are virtually ubiquitous in the construction industry, being found in use at nearly any construction job site, large or small. Along with the use of such materials are apparatus for transporting, mixing, and pouring the materials. Large cement trucks are frequently seen at construction job sites, transporting concrete to a site and, ideally, dispensing the concrete directly into forms where needed.

Frequently, however, such vehicles cannot gain access to dispense concrete precisely where needed. Instead, the concrete may be dispensed into wheelbarrows for transport, or pumped some distance with a concrete pump, or otherwise transported from the truck to the application site. Using a wheelbarrow, many trips may be needed even for relatively small jobs. On muddy or uneven terrain, maneuvering the wheelbarrow may be difficult and the process is prone to spillage, leading to wasted concrete and increased cost of post-construction cleanup at the site. Additionally, for high columns and other work where the concrete must be applied at a somewhat elevated location, a wheelbarrow does not adequately solve the problem of raising the concrete. Concrete pumps, particularly for smaller jobs, are too costly to acquire or rent and may be difficult to obtain.

One solution to handling concrete on a job site has been to use the bucket of a loader type vehicle, such as a front-end loader or skid loader, to carry concrete. While a loader bucket can easily carry concrete around a job site to locations that are inaccessible to a cement truck, the loader bucket is not, by itself, ideally suited for pouring the concrete. Various devices have been devised to replace or modify a loader bucket for transporting and pouring concrete.

U.S. Pat. No. 5,885,053, issued on Mar. 23, 1999 to M. Deye, discloses a container for transporting and placing flowable materials. The container is mounted onto a skid loader in place of a conventional loader bucket.

U.S. Pat. No. 5,829,949, issued on Nov. 3, 1998, and U.S. Pat. No. 5,938,398, issued on Aug. 17, 1999, both to R. Brown, disclose a dispensing bucket apparatus that removably attaches to a loader vehicle. The apparatus is a container, having an exit opening in its front end that is adapted to receive and hold a flowable material. Sidewalls of the bucket converge toward the front opening to form a funnel that directs the flowable material to the exit opening. However, the device replaces, rather than modifies, the loader vehicle's conventional loader bucket.

U.S. Pat. No. 5,692,875, issued on Dec. 2, 1997 to D. Bowman, discloses a chute assembly to be mounted on a front end loader or the like. The chute has side and bottom walls adapted to make a sealing fit with the sides and bottom of the loader bucket. Sidewalls form a funnel for directing a flowable material contained therein toward a front end opening. The device attaches along the lower front edge of the loader bucket, extending from the bucket. In one embodiment, the device is hinged and hydraulically movable into and out of place in the bucket.

U.S. Pat. No. 4,068,771, issued on Jan. 17, 1978 to J. Zimmerman, discloses a carrier bucket and apparatus for removably attaching the carrier bucket to a loader bucket. The carrier bucket includes bottom, side, and back walls that conform to the shape of the loader bucket so that the carrier bucket forms a liner within the loader bucket.

U.S. Pat. No. 3,517,863, issued on Jun. 30, 1970 to J. Graham, discloses an attachment for mounting to a loader bucket for facilitating dispensing or pouring of a flowable material. The attachment has side and bottom walls, the sidewalls being angled toward a front opening.

None of the above inventions and patents, taken either singly or in combination, is seen to describe the instant invention as claimed. Thus a skid loader attachment for pouring concrete solving the aforementioned problems is desired.

### SUMMARY OF THE INVENTION

The skid loader attachment for pouring concrete is an accessory attachment that can be easily installed in a loader bucket to adapt the loader bucket for carrying and pouring concrete and other flowable structural materials. The skid loader attachment for pouring concrete mounts within a loader bucket to form, along with the loader bucket, a container for carrying and pouring a flowable structural material, such as concrete.

A generally square concrete chute forms the center of the skid loader attachment. Angled walls extend outward from each side of the chute. With the attachment placed into a loader bucket, the walls of the attachment extend to the sides of the bucket to form front walls of a container, the loader bucket forming the bottom, side, and rear walls of the container.

A sliding gate at the front of the chute allows the chute to be opened for dispensing concrete, or closed to contain the concrete, such as during transport.

These and other features of the present invention will become readily apparent upon further review of the following specification and drawings.

### BRIEF DESCRIPTION OF THE DRAWINGS

FIG. 1 is an environmental, perspective view of a skid loader attachment for pouring concrete according to the present invention.

FIG. 2 is a perspective view of a skid loader attachment for pouring concrete according to the present invention.

FIG. 3 is a front view of a skid loader attachment for pouring concrete according to the present invention.

FIG. 4 is a top view of a skid loader attachment for pouring concrete according to the present invention.

FIG. 5 is a side view of a skid loader attachment for pouring concrete according to the present invention.

FIG. 6 is a partially exploded perspective view of an embodiment of the skid loader attachment for pouring concrete according to the present invention having adjustable wall members.

Similar reference characters denote corresponding features consistently throughout the attached drawings.

### DETAILED DESCRIPTION OF THE PREFERRED EMBODIMENT

The present invention is a skid loader attachment for pouring concrete, designated generally as 10 in the drawings. The skid loader attachment for pouring concrete 10 is installable within the bucket 100 of a skid loader or front end loader type of vehicle to convert the loader's bucket 100 into a container for transporting and pouring a flowable structural material such as concrete. It can be recognized that the skid loader attachment for pouring concrete 10 is also useful for a great variety of flowable materials, such as grains, feed for livestock, fertilizers and other agricultural products, as well as other materials too numerous to list.

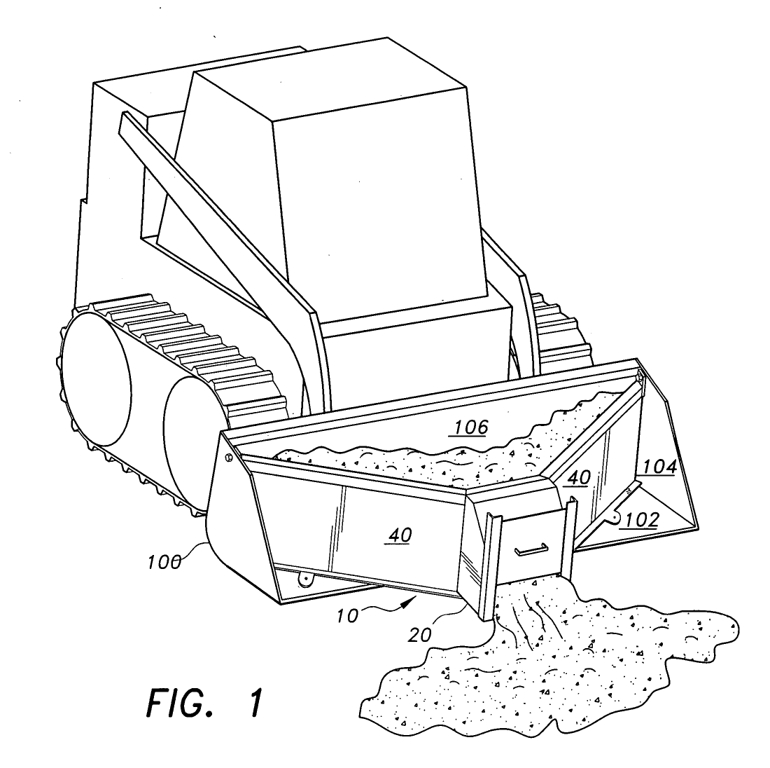

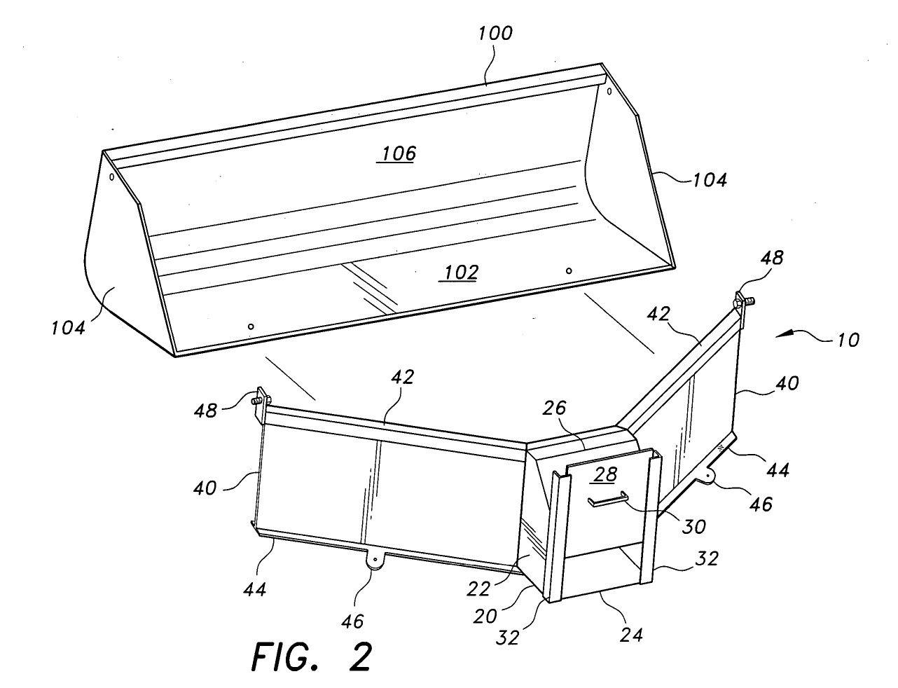

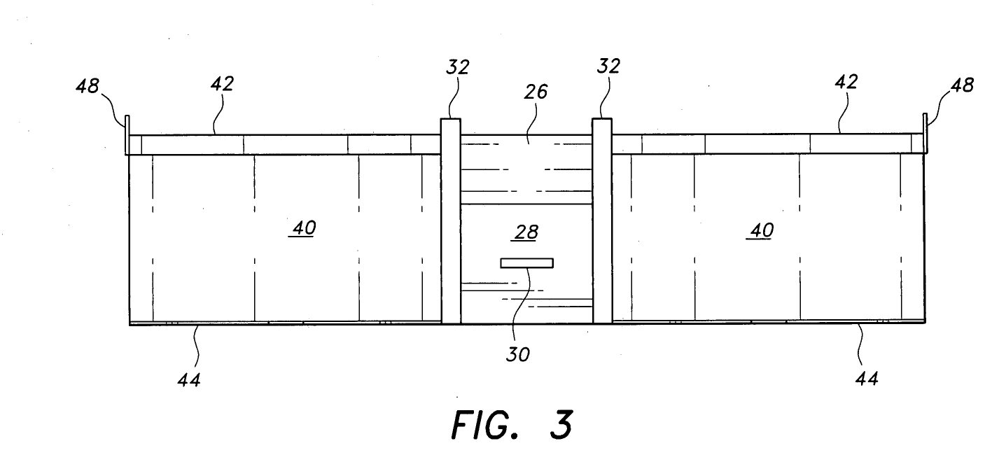

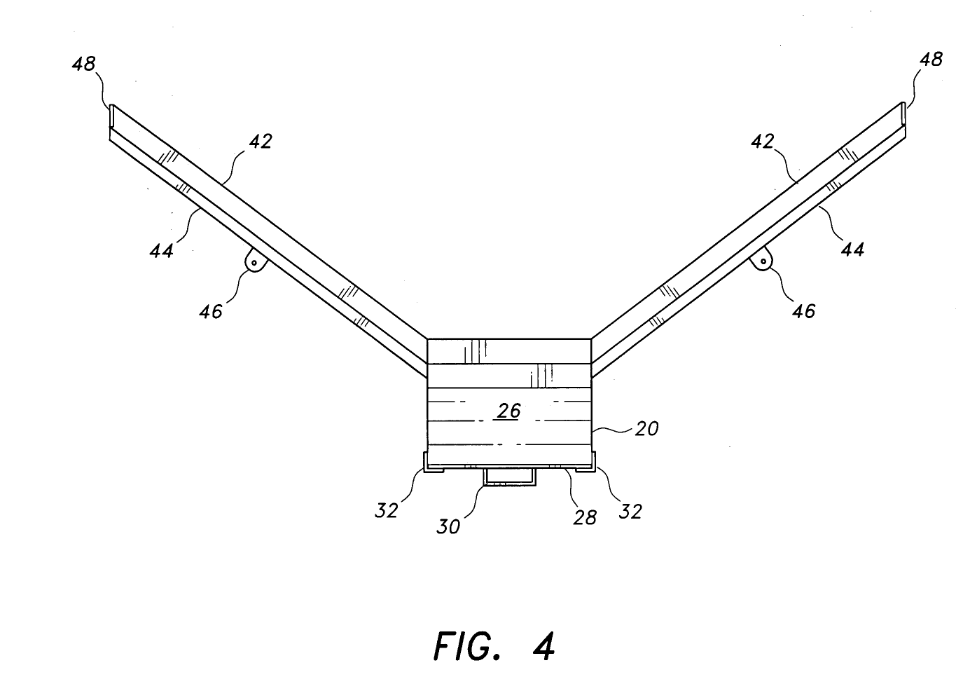

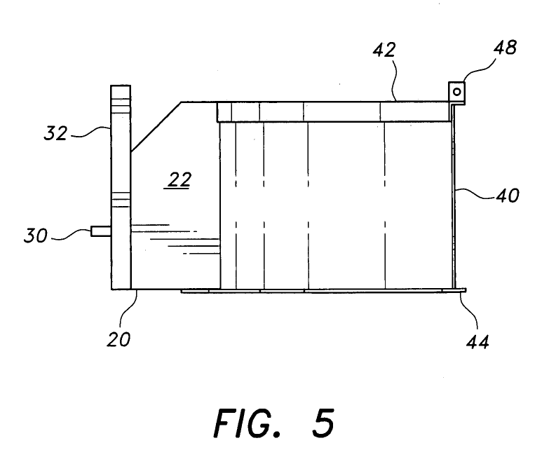

Referring to FIGS. 1-5, a chute 20 comprising side portions 22, a bottom 24 and a top 26 forms the central structure of the skid loader attachment for pouring concrete 10. A moveable gate 28 is slidably disposed on the front of the chute 20, and is movable between a closed position and an open position. Angle brackets 32, disposed along front edges of the side portions 22, form a track for the gate 28. A handle 30, disposed on the gate 28, facilitates operation of the gate 28. While such a simple manually operated gate is desirable to maintain low manufacturing costs and low maintenance of the skid loader attachment for pouring concrete 10, it can be recognized that a variety of hydraulic and other operating mechanisms can be added to operate the gate 28.

Wall members 40 extend from each side of the chute 20, angled rearward from the rear of the chute 20 to form a funnel along with the chute 20. The wall members 40 are generally rectangular plates, attached to rear edges of the side portions 22 of the chute 20. The top edge of each of the wall members 40 is reinforced by a length of angle iron 42. A mounting tab 48, having an aperture suitable for receiving a mounting bolt, is disposed on the outer side edge of each wall member 40, preferably attached to the angle iron 42. A flange 44 is disposed along the bottom edge of each of the wall members 40. At least one mounting tab 46, having an aperture suitable for receiving a mounting bolt, extends from the flange 44 of each wall member 40.

The skid loader attachment for pouring concrete 10 mounts inside the bucket 100 of a loader vehicle, resting on the floor 102 of the bucket. The outer side edges of the wall members 40 meet, and are fastened to, the sidewalls 104 of the bucket 100. The skid loader attachment for pouring concrete 10, along with the loader bucket bottom 102, side 104, and rear 106 walls, forms a container, with the attachment 10 forming the container front wall and pouring chute 20. Because, in this arrangement, the bucket floor 102 functions as the container floor, the skid loader attachment for pouring concrete 10 does not itself require a floor member, allowing the skid loader attachment for pouring concrete 10 to be manufactured at a lower cost and lighter weight.

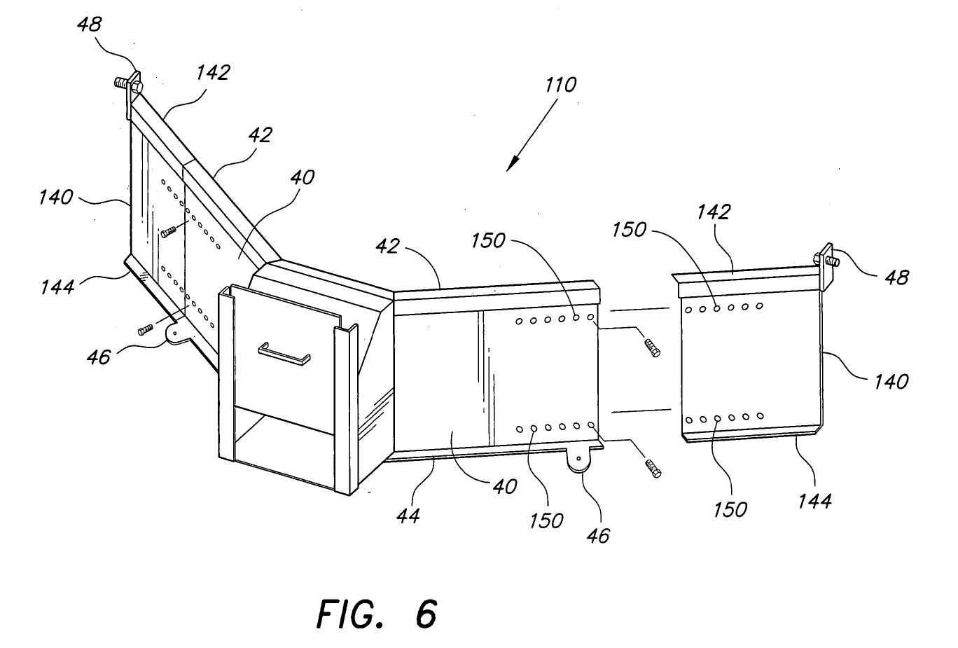

Turning now to FIG. 6, an embodiment of the skid loader attachment for pouring concrete 110 is illustrated with wall panel extensions 140 for adjusting the length of wall members 40. The wall panel extensions 140 are generally rectangular plates. The top edge of each of the wall panel extensions 140 is reinforced by a length of angle iron 142. Mounting tab 48 is disposed on the outer side edge of each wall panel extension 140, preferably attached to the angle iron 142. A flange 144 is disposed along the bottom edge of each of the wall panel extensions 140.

The wall panel extensions 140 overlap the wall members 40 (which, in this embodiment, lack mounting tabs 48), and are joined to the wall members 40 by a plurality of bolts. A row of apertures 150 is formed along top and bottom edges of each of the wall members 40 and the wall panel extensions 140 to allow the wall members 40 and wall panel extensions 140 to be bolted together to adjust the length of the wall panel to accommodate differently sized loader buckets.

It is to be understood that the present invention is not limited to the embodiments described above, but encompasses any and all embodiments within the scope of the following claims.

1. A skid loader attachment for pouring concrete, comprising:
a chute having an open front end and an open rear end, and a hollow interior adapted for passage of a flowable material;
a movable gate disposed on the front end of said chute, the gate being movable between a closed position covering the front end and an open position wherein the front end is at least partially uncovered; and
a pair of wall members having top and bottom edges, each of the wall members having an inner side edge fastened to said chute and an outer side edge, the wall members extending laterally from opposite sides of the rear end of said chute.

2. The skid loader attachment for pouring concrete according to claim 1, wherein each of said wall members is angled rearwardly from said chute.

3. The skid loader attachment for pouring concrete according to claim 1, wherein each of said wall members further comprises a mounting tab disposed on the outer side edge of said wall member.

4. The skid loader attachment for pouring concrete according to claim 1, wherein each of said wall members further comprises a reinforcing member disposed along the top edge of said wall member.

5. The skid loader attachment for pouring concrete according to claim 4, wherein each of said wall members further comprises a mounting tab disposed on said reinforcing member at the outer side edge of said wall member.

6. The skid loader attachment for pouring concrete according to claim 1, wherein each of said wall members further comprises at least one mounting tab disposed along the bottom edge of said wall member.

7. The skid loader attachment for pouring concrete according to claim 1, wherein each of said wall members further comprises a flange disposed along the bottom edge of said wall member.

8. The skid loader attachment for pouring concrete according to claim 7, wherein each of said wall members further comprises at least one mounting tab disposed on said flange.

9. The skid loader attachment for pouring concrete according to claim 1, further comprising first and second track members disposed on the front end of said chute, said gate being slidably retained by the track members.

10. The skid loader attachment for pouring concrete according to claim 1, further comprising a handle disposed on said gate.

11. A skid loader attachment for pouring concrete, comprising:
a chute having an open front end and an open rear end, and a hollow interior adapted for passage of a flowable material;
a movable gate disposed on the front end of said chute, the gate being movable between a closed position covering the front end and an open position wherein the front end is at least partially uncovered;
a pair of wall members having top and bottom edges, each of the wall members having an inner side edge fastened to said chute and an outer side edge, the wall members extending laterally from opposite sides of the rear end of said chute; and
a wall panel extension partially overlapping and extending laterally from each of said wall members; and
means for selectively adjusting the extent of overlap of said extensions with said wall members, whereby the wall members are length adjustable.

12. The skid loader attachment for pouring concrete according to claim 11, wherein each of said wall members is angled rearwardly from said chute.

13. The skid loader attachment for pouring concrete according to claim 11, wherein each of said wall panel extensions further comprises a mounting tab disposed on an outer side edge of said wall panel extensions.

14. The skid loader attachment for pouring concrete according to claim 11, wherein each of said wall panel extensions further comprises a reinforcing member disposed along the top edge of said wall panel extension.

15. The skid loader attachment for pouring concrete according to claim 14, wherein each of said wall panel extensions further comprises a mounting tab disposed on said reinforcing member at an outer side edge of said wall panel extension.

16. The skid loader attachment for pouring concrete according to claim 11, wherein each of said wall members further comprises a flange disposed along the bottom edge of said wall member.

17. The skid loader attachment for pouring concrete according to claim 16, wherein each of said wall members further comprises at least one mounting tab disposed on said flange.

18. The skid loader attachment for pouring concrete according to claim 11, wherein each of said wall extensions further comprises a flange disposed along the bottom edge of said wall panel extensions.

19. The skid loader attachment for pouring concrete according to claim 11, further comprising first and second track members disposed on the front of said chute, said gate being slidably retained by the track members.

20. The skid loader attachment for pouring concrete according to claim 1, further comprising a handle disposed on said gate.
